(19) United States
(12) Patent Application Publication
(10) Pub. No.: US 2020/0409388 A1
(43) Pub. Date: Dec. 31, 2020

(54) CONTROLLER, CONTROL METHOD, AND PROGRAM

(71) Applicant: SONY CORPORATION, TOKYO (JP)

(72) Inventors: KEISUKE MAEDA, TOKYO (JP); SHINICHI TAKEMURA, KANAGAWA (JP)

(21) Appl. No.: 16/978,628

(22) PCT Filed: Jan. 11, 2019
(86) PCT No.: PCT/JP2019/000778

§ 371 Date: Sep. 4, 2020

(30) Foreign Application Priority Data
Mar. 15, 2018 (JP) 2018-047918

(51) Int. Cl. G05D 1/02

(52) U.S. Cl. CPC G05D 1/0274; G05D 1/0219; G05D 1/0221

(57) ABSTRACT

[Overview] [Problem to be Solved] To more smoothly execute a cooperative action among a plurality of mobile bodies sharing an action plan. [Solution] A controller including: a plan map creation section that creates an action plan map for making an action plan of a first mobile body from an outside world map with use of an action plan of a second mobile body; and an error detection section that detects an error between the action plan of the second mobile body and an observation result of an action of the second mobile body, and the plan map creation section updating the action plan map with use of the detected error.

### TECHNICAL FIELD

The present disclosure relates to a controller, a control method, and a program.

### BACKGROUND ART

In general, an autonomously movable robot or the like (hereinafter, also referred to as a mobile body) makes an action plan with use of an outside world map. Specifically, the mobile body creates a map for an action plan indicating a movable region on the basis of the outside world map, and plans an optimal moving route with use of the created map for the action plan.

Here, in a case where each of a plurality of mobile bodies makes an action plan, for example, each of the mobile bodies may determine that a passageway having a width of only one mobile body is movable, and make an action plan to pass through the passageway. In such a case, a plurality of mobile bodies come across each other in the passageway, which interferes with smooth execution of each of the action plans in some cases.

Accordingly, in a case where a plurality of mobile bodies is used, it has been proposed that the mobile bodies share an action plan with each other and perform a cooperative operation among the plurality of mobile bodies.

For example, PTL 1 below proposes a technology in which, in a case where there is a possibility that a plurality of mobile robots encounter each other, a movement plan of one of the mobile robots or movement planes of both the mobile robots are modified or temporarily halted in accordance with priorities of tasks to be executed by the respective robots, and entire optimization is performed.

### CITATION LIST

### Patent Literature

PTL 1: Japanese Unexamined Patent Application Publication No. 2006-326703

### SUMMARY OF THE INVENTION

### Problems to be Solved by the Invention

However, in the technology proposed in PTL 1, it is assumed that there is no error in map information used to make an action plan in each of the mobile bodies, and a shared action plan. For this reason, for example, in a case where there is an error in an action plan shared among the respective mobile bodies, the plurality of mobile bodies is not able to smoothly execute a cooperative operation in some cases.

In addition, in mobile bodies that act in an unspecified region, an outside field map is created by each of the mobile bodies; therefore, coordinate systems of the outside field maps created for the respective mobile bodies may be different. In such a case, a correspondence relation of a coordinate system of a shared action plan is unknown, which makes it difficult for a plurality of mobile bodies to smoothly perform a cooperative operation.

Accordingly, the present disclosure proposes novel and improved controller, control method, and program that make it possible to cause a plurality of mobile bodies sharing an action plan to execute an action plan more smoothly.

### Means for Solving the Problems

According to the present disclosure, there is provided a controller including: a plan map creation section that creates an action plan map for making an action plan of a first mobile body from an outside world map with use of an action plan of a second mobile body; and an error detection section that detects an error between the action plan of the second mobile body and an observation result of an action of the second mobile body, the plan map creation section updating the action plan map with use of the detected error.

In addition, according to the present disclosure, there is provided a control method including: creating an action plan map for creating an action plan of a first mobile body from an outside world map with use of an action plan of a second mobile body; detecting an error between the action plan of the second mobile body and an observation result of an action of the second mobile body; and updating the action plan map with use of the detected error.

In addition, according to the present disclosure, there is provided a program for causing a computer to function as: a plan map creation section that creates an action plan map for making an action plan of a first mobile body from an outside world map with use of an action plan of a second mobile body; and an error detection section that detects an error between the action plan of the second mobile body and an observation result of an action of the second mobile body, the plan map creation section being caused to function to update the action plan map with use of the detected error.

According to the present disclosure, even in a case where there is an error in the shared action plan of the second mobile body, it is possible to correct the error in the action plan on the basis of the observation result of the second mobile body. According to the present disclosure, this makes it possible to remake the action plan of the first mobile body on the basis of the action plan in which the error is corrected.

### Effects of the Invention

As described above, according to the present disclosure, it is possible for a plurality of mobile bodies sharing an action plan to execute the action plan more smoothly.

It is to be noted that the effects described above are not necessarily limitative. Any of the effects indicated in this description or other effects that may be understood from this description may be exerted in addition to the effects described above or in place of the effects described above.

### BRIEF DESCRIPTION OF DRAWINGS

FIG. 1 is a schematic diagram for describing an overview of a technology according to the present disclosure.

FIG. 2 is a block diagram illustrating a configuration example of a controller according to an embodiment of the present disclosure.

FIG. 3 is a flowchart illustrating an example of a flow of processing to be executed by a mobile body recognition section.

FIG. 4A is an explanatory diagram illustrating an example of an image acquired as measurement data.

FIG. 4B is an explanatory diagram illustrating an example of an image in which a detection region is estimated from the image illustrated in FIG. 4A.

FIG. 4C is an explanatory diagram illustrating an example in which mobile body candidates corresponding to an image of the detection region are presented.

FIG. 4D is an explanatory diagram illustrating an example of an image representing a distance from an object in gray scale.

FIG. 4E is an explanatory diagram illustrating an example in which a three-dimensional position of a second mobile body is estimated from an azimuth angle of and a distance from the second mobile body.

FIG. 5 is an explanatory diagram illustrating an example in which a traveling direction and velocity of the second mobile body are estimated by temporally accumulating a position of the second mobile body.

FIG. 6A is a flowchart illustrating an example of a flow of processing for detecting an error by comparing an action plan of the second mobile body with an observation result of the second mobile body.

FIG. 6B is a flowchart illustrating an example of a flow of processing for detecting an error that the second mobile body is not observed.

FIG. 7A is an explanatory diagram illustrating an example of an variation of an error and correction.

FIG. 7B is an explanatory diagram illustrating an example of a variation of an error and correction.

FIG. 7C is an explanatory diagram illustrating an example of a variation of an error and correction.

FIG. 7D is an explanatory diagram illustrating an example of a variation of an error and correction.

FIG. 7E is an explanatory diagram illustrating an example of a variation of error and correction.

FIG. 7F is an explanatory diagram illustrating an example of a variation of an error and correction.

FIG. 7G is an explanatory diagram illustrating an example of a variation of an error and correction.

FIG. 8A is an explanatory diagram illustrating a specific example of an action plan map that reflects an action plan of the second mobile body.

FIG. 8B is an explanatory diagram illustrating an example of an action plan of a first mobile body planned on the basis of the action plan map illustrated in FIG. 8A.

FIG. 9 is a flowchart illustrating an operation example of the controller according to the embodiment of the present disclosure.

FIG. 10 is a block diagram illustrating a hardware configuration example of the controller according to the embodiment of the present disclosure.

### MODES FOR CARRYING OUT THE INVENTION

The following describes a preferred embodiment of the present disclosure in detail with reference to the accompanying drawings. It is to be noted that, in this description and the accompanying drawings, components that have substantially the same functional configuration are denoted by the same reference numerals, and thus redundant description thereof is omitted.

It is to be noted that description is given in the following order.
1. Overview of Technology according to Present Disclosure
2. Configuration Example of Controller
3. Specific Processing Example of Controller
4. Operation Example of Controller
5. Hardware Configuration Example
6. Conclusion

### <1. Overview of Technology According to Present Disclosure>

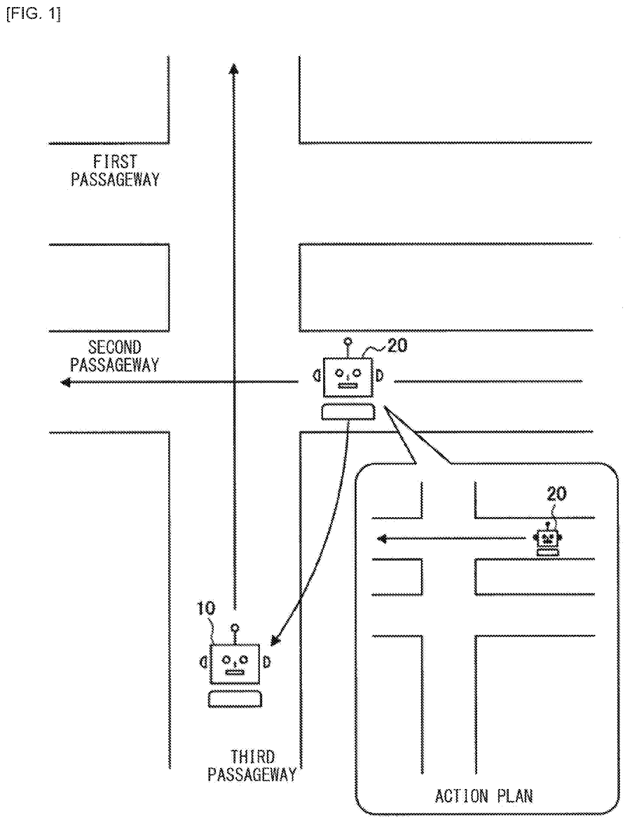

An overview of a technology according to the present disclosure is described with reference to FIG. 1. FIG. 1 is a schematic diagram for describing the overview of the technology according to the present disclosure.

First, a case where a first mobile body 10 and a second mobile body 20 make respective action plans and move in the same region in the same time period.

The first mobile body 10 and the second mobile body 20 are autonomously movable mobile bodies. The first mobile body 10 and the second mobile body 20 each make an action plan with use of an outside world map and execute an action according to the thus-made action plan. For example, in a case where a movement that is one type of action is executed, each of the first mobile body 10 and the second mobile body 20 first creates a grid map indicating a region passable by itself with use of the outside world map. Next, the first mobile body 10 and the second mobile body 20 each apply a graph search algorithm such as Dijkstra's method to the grid map and select an optimal route, which makes it possible to make an action plan for the movement.

For example, as illustrated in FIG. 1, the first mobile body 10 makes an action plan to move straight through a third passageway by a method as described above. In contrast, the second mobile body 20 makes an action plan to move straight through a first passageway orthogonal to the third passageway by the method as described above. Consequently, in a case where the first mobile body 10 and the second mobile body 20 move according to the respective action plans in the same time period, there is a possibility that the first mobile body 10 and the second mobile body 20 come across each other or collide with each other at an intersection of the first passageway and the third passageway.

Accordingly, as illustrated in FIG. 1, the second mobile body 20 transmits its own action plan to the first mobile body 10 and shares the action plan with the first mobile body 10, thereby attempting to avoid coming across or colliding with the first mobile body 10. For example, a timing at which the first mobile body 10 passes the intersection of the first passageway and the third passageway and a timing at which the second mobile body 20 passes the intersection are shifted from each other, thereby attempting to avoid the first mobile body 10 and the second mobile body 20 from coming across each other or colliding with each other.

However, as illustrated in FIG. 1, in a case where the second mobile body 20 is actually executing an action different from the action plan, avoidance of coming across each other or colliding with each other described above does not work. Consequently, there is a possibility that the second mobile body 20 comes across or collides with the first mobile body 10 at the intersection of a second passageway and the third passageway.

In the technology according to the present disclosure, in a case where the first mobile body 10 observes that the second mobile body 20 is executing the action different the action plan, the first mobile body 10 corrects the received action plan of the second mobile body 20 on the basis of an observation result of the second mobile body 20. Thereafter, the first mobile body 10 updates the action plan to avoid coming across or colliding with the second mobile body 20 moving straight through the second passageway at the intersection of the second passageway and the third passageway. This makes it possible for the first mobile body 10 to execute a cooperative action with the second mobile body 20 more smoothly even in a case where the action plan received from the second mobile body 20 is different from the actual action of the second mobile body 20.

Accordingly, even in a case where there is an error or uncertainty in the shared action plan from the second mobile body 20, the first mobile body 10 corrects the shared action plan on the basis of the observed actual action of the second mobile body 20, which makes it possible to acquire a more accurate action plan. This allows the first mobile body 10 to predict not only the current action of the second mobile body 20, but also a future action of the second mobile body 20 on the basis of the corrected action plan, thereby allowing for a cooperative action with the second mobile body 20.

In addition, according to the technology according to the present disclosure, it is possible for the first mobile body 10 to improve accuracy of the action plan received from the second mobile body 20 on the basis of the actual action of the observed second mobile body 20. This allows the first mobile body 10 to execute the cooperative action with the second mobile body 20 with high accuracy even in a case where frequency of sharing the action plan with the second mobile body 20 is low or even in a case where the amount of information about the shared action plan is small.

### <2. Configuration Example of Controller>

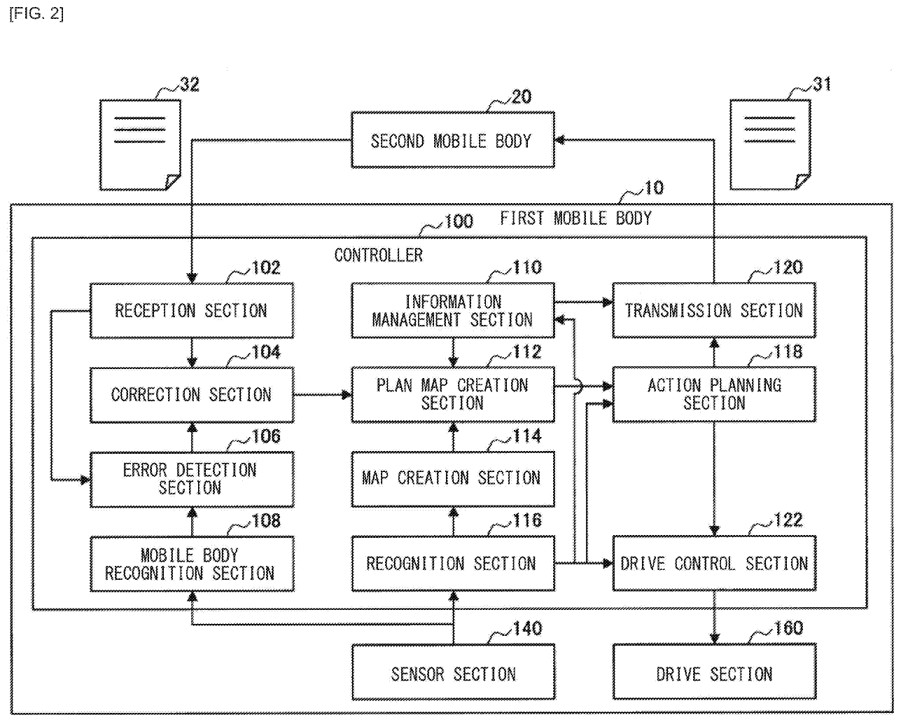

Next, a configuration example of a controller according to an embodiment of the present disclosure is described with reference to FIG. 2. FIG. 2 is a diagram illustrating a configuration example of a controller 100 according to the present embodiment.

As illustrated in FIG. 2, the controller 100 controls driving of the first mobile body 10 by controlling a drive section 160 on the basis of inputs from a reception section 102 and a sensor section 140. Specifically, the controller 100 includes the reception section 102, a correction section 104, an error detection section 106, a mobile body recognition section 108, an information management section 110, a plan map creation section 112, a map creation section 114, a recognition section 116, an action planning section 118, a transmission section 120, and a drive control section 122. The controller 100 may be included in the first mobile body 10 together with the sensor section 140 and the drive section 160, for example.

The sensor section 140 includes various sensors, and measures a state of the outside world or the first mobile body 10 and outputs measured data. For example, the sensor section 140 may include various cameras such as an RGB camera, a gray-scale camera, a stereo camera, a depth camera, an infrared camera, or a TOF (Time of Flight) camera as sensors that measure the state of the outside world, and may include various ranging sensors such as a LIDAR (Laser Imaging Detection and Ranging) or a RADAR (Radio Detecting and Ranging) sensor. The sensor section 140 may also include, for example, an encoder, a voltmeter, an ammeter, a strain gauge, a pressure gauge, an IMU (Inertial Measurement Unit), a thermometer, a hygrometer, and the like as sensors that measure the state of the first mobile body 10. Note that it goes without saying that the sensor section 140 may include any known sensor, other than the sensors described above, that measures the state of the outside world or the first mobile body 10.

The recognition section 116 recognizes the states of the outside world and the first mobile body 10 on the basis of data measured by the sensor section 140. Specifically, the recognition section 116 may recognize the outside world by obstacle recognition, shape recognition (i.e., wall recognition or floor recognition), object recognition, marker recognition, character recognition, white line or lane recognition, or speech recognition on the basis of measurement data inputted from the sensor section 140. Alternatively, the recognition section 116 may recognize the state of the first mobile body 10 by position recognition, motion state (such as velocity, acceleration, or jerk) recognition, or body state (such as a power remaining amount, a temperature, or a joint angle) recognition. It is possible to perform the recognition described above to be performed by the recognition section 116 with use of a known recognition technology. The recognition to be performed by the recognition section 116 may be performed on the basis of a predetermined rule or a machine-learning algorithm, for example.

The map creation section 114 creates an outside world map on the basis of a recognition result of the outside world by the recognition section 116. Specifically, the map creation section 114 creates the outside world map by temporally accumulating a recognition result of the outside world by the recognition section 116 or by combining a plurality of different types of recognition results. For example, the map creation section 114 may create an obstacle map or a moving region map indicating a region passable by the first mobile body 10, may create an object map indicating existence positions of various objects, or may create a topological map indicating names, relevance, or meanings of respective regions. It is to be noted that the map creation section 114 may create a plurality of different types of maps in accordance with uses, types, or conditions.

The plan map creation section 112 creates an action plan map in which information necessary to make an action plan of the first mobile body 10 is embedded, on the basis of the outside world map created by the map creation section 114 and body information of the first mobile body 10, the action plan of the second mobile body 20. Specifically, the plan map creation section 112 determines what meaning each of regions and objects included in the outside world map has with respect to the first mobile body 10, and creates an action plan map in which each of thus-determined meanings is embedded. The action plan map created by the plan map creation section 112 may include a map including a temporal axis such as a three-dimensional or four-dimensional map. That is, the action plan map created by the plan map creation section 112 may include a map in consideration of a lapse of time. It is to be noted that the plan map creation section 112 may create a plurality of different types of maps in accordance with uses, types, or conditions.

For example, in a case where the first mobile body 10 is a mobile body traveling on a ground surface, it is possible for the plan map creation section 112 to set an obstacle and a hole existing on the ground surface as non-passible regions in the outside world map and set an obstacle existing at a position higher than the height of the first mobile body 10 as a passable region. In addition, it is possible for the plan map creation section 112 to set a puddle in the outside world map as either a passible region or a non-passible region depending on whether or not the first mobile body 10 is waterproof.

In the present embodiment, using the action plan of the second mobile body 20 makes it possible for the plan map creation section 112 to create an action plan map in which information about a cooperative action with the second mobile body 20 is embedded in each of regions and objects included in the outside world map. For example, it is possible for the plan map creation section 112 to set a region where the second mobile body 20 passes in the outside world map as a non-passable region for the first mobile body 10. In addition, it is possible for the plan map creation section 112 to set, as checkpoints, a point and time at which baggage or the like is delivered from the second mobile body 20 in the outside world map.

In the present embodiment, there is a possibility that the action plan of the second mobile body 20 is corrected on the basis of an observation result of the second mobile body 20. In such a case, the plan map creation section 112 may recreate an action plan map of the first mobile body 10 on the basis of the corrected action plan of the second mobile body 20.

The information management section 110 manages the body information of the first mobile body 10. Specifically, the information management section 110 manages information such as body specifications stored in a built-in storage medium and information related to a state of a body recognized by the recognition section 116. For example, the information management section 110 may manage individual identification information written to the built-in storage medium, a body shape, information related to the mounted sensor section 140 or the mounted drive section 160, or power source information (such as a drive voltage or a power source capacity). For example, the information management section 110 may manage a present body shape of the first mobile body 10 calculated by a shape of each component included in the body of the first mobile body 10 and information about a joint angle for coupling each component recognized by the recognition section 116.

The action planning section 118 makes an action plan of the first mobile body 10 on the basis of the action plan map created by the plan map creation section 112 and the body information of the first mobile body 10 managed by the information management section 110. Specifically, the action planning section 118 may make an action plan having a hierarchical structure such as an action policy, a long-term action, and a short-term action, or may make a plurality of action plans to be executed simultaneously. For example, the action planning section 118 may make a topological route plan using a wide range topological map, a coordinate route plan using an obstacle in an observation range, or a motion plan including dynamics to be executed by the first mobile body 10. It is to be noted that, for example, the action planning section 118 may make an action plan of the first mobile body 10 on the basis of an external action instruction, or may autonomously make an action plan of the first mobile body 10.

In the present embodiment, in a case where the action plan of the second mobile body 20 is corrected, there is a possibility that the action plan map created by the plan map creation section 112 is recreated. In such a case, the action planning section 118 may recreate the action plan of the first mobile body 10 on the basis of the updated action plan map.

The drive control section 122 outputs a control command for driving the drive section 160 to perform a desired action, on the basis of the action plan made by the action planning section 118 and the body information of the first mobile body 10. Specifically, the drive control section 122 calculates an error between an action planned by the action plan and a current state of the first mobile body 10, and outputs a control command for driving the drive section 160 to reduce the calculated error. The drive control section 122 may hierarchically generate a control command.

The drive section 160 drives the first mobile body 10 on the basis of a control command or the like from the controller 100. For example, the drive section 160 is a module that performs output to real space and may include an engine, a motor, a speaker, a projector, a display, or a light emitter (for example, a light bulb, an LED, a laser, or the like).

The transmission section 120 transmits an action plan 31 of the first mobile body 10 and the body information of the first mobile body 10 to the second mobile body 20. Specifically, the transmission section 120 may be a wireless communication module of a known communication system. For example, the transmission section 120 may transmit the body information of the first mobile body 10 as illustrated in Table 1 below, and the action plan 31 of the first mobile body 10 as illustrated in Table 2 below.

TABLE 1

| | Classification | Component | Details |
|---|---|---|---|
| Body | Body ID | Body Shape ID | Vehicle model, etc. |
| Information | | Individual Identifier | Serial number |
| | Power Source | Voltage | Power source voltage |
| | Information | Power Remaining | Remaining power capacity |
| | | Amount | |
| | | Remaining Operating | Estimated operating time |
| | | Time | |
| | Priority | Body Priority | Priority in cooperative action |
| | State | Sensor State | Normal or abnormal, etc. |
| | | Actuator State | Normal or abnormal, etc. |
| | | Self-position Grasping | Normal, inaccurate, or lost, etc. |
| | | State | |
| | Body Shape | Component Shape | Shape of each component, position of |
| | | | sensor or actuator, etc. |
| | | Two-dimensional | Occupied shape of specific plane, etc. |
| | | Occupied Region | |
| | | Three-dimensional | Occupied shape of two-dimensional |
| | | Occupied Region | space, etc. |

TABLE 2

| | Classification | Component | Details |
|---|---|---|---|
| Action | Plan | ID | Action identifier |
| Plan | Information | Priority | Action priority |
| | | Planned Time | Time when action plan is made |
| | | Start Time | Start time of planned action |
| | | End Time | End time of planned action |
| | | Plan Version Number | Plan version number (number increased by re-planning) |
| | | Type of Information | New, updated, temporarily halted, cancelled, etc. |
| | Action Range | Locality Information | Name or ID of country, district, locality, etc. |
| | | Building Information | Name or ID of building, etc. |
| | | Floor Information | Name or ID of floor, etc. |
| | | Room Information | Name or ID of room, etc. |
| | | Region Information | Two-dimensional or three-dimensional region |
| | | | information, etc. |
| | Action | Conditional Branch | Condition to switch action |
| | Flowchart | Repetition | Repetition time, duration, number of repetitions, etc. |
| | | Synchronization | Action to be synchronized, etc. |
| | Low-order | Movement Plan | Via point information (ID, position, and time) |
| | Action | | Via motion state (position, velocity, acceleration, and |
| | | | jerk of body, distribution thereof, etc.) |
| | | Motion Plan | Via point information (ID and time) |
| | | | Via motion state (control, position, velocity, |
| | | | acceleration, and jerk of each joint, distribution thereof, |
| | | | etc.) |
| | | Observation Plan | Observation object and operation plan of observation |
| | | | device (operation information at each time) |
| | | Projection Plan | Projected image, start time, end time, playback time, |
| | | | playback speed, number of repetitions, operation at each |
| | | | time (projection position, attitude, trapezoid correction, |
| | | | focal length, etc.) |
| | | Audio Plan | Playback sound source, start time, end time, playback |
| | | | time, playback speed, number of repetitions, playback |
| | | | direction, operation at each time (volume, etc.) |
| | | Sound Recording plan | Start time, end time, duration, used microphone, sound |
| | | | recording direction, operation at each time (sensitivity, |
| | | | noise cancellation, etc.) |
| | | Visual Recording Plan | Start time, end time, duration, used camera, operation at |
| | | | each time (zoom, exposure, aperture, etc.) |

As illustrated in Table 1, the body information of the first mobile body 10 to be transmitted by the transmission section 120 may include information classified into any of the body ID, the power source information, the priority, the state, the body shape, and the like. For example, the body ID may be used to identify the first mobile body 10. The power source information and the priority may be used to adjust the priority in performing a cooperative action. The state and the body shape may be used to consider the state of the first mobile body 10 in performing a cooperative action.

As illustrated in Table 2, the action plan 31 of the first mobile body 10 to be transmitted by the transmission section 120 may include information classified into any of the plan information, the action range, the action flowchart, the low-order action, and the like. For example, the ID may be used to identify an action. The priority may be used to adjust the order of cooperative actions. The time may be used to specify time affected by an action. The version number and the type of information may be used to control a cooperative action in a case where updating of an action plan, or the like is to be performed. The action range may be used to determine a range affected by the first mobile body 10. The action flowchart may be used to indicate an overview of an action plan that transitions an action in accordance with the outside world or the body state of the first mobile body 10. The low-order action is an action referred to as processing defined in the action flowchart, and an action plan is formed by hierarchically combining these respective low-order actions.

The reception section 102 receives an action plan 32 of the second mobile body 20 and body information of the second mobile body 20. Specifically, the reception section 102 may be a wireless communication module of a known communication system. For example, the reception section 102 may receive, from the second mobile body 20, the action plan 32 and the body information similar to the action plan 31 of the first mobile body 10 and the body information of the first mobile body 10 described above.

It is to be noted that as with the first mobile body 10, the second mobile body 20, in which the transmission section 120 and the reception section 102 transmit and receive the action plans 31 and 32, may be another mobile body that performs an action on the basis of an action plan. The second mobile body 20 may be an autonomous mobile body, or may be a mobile body that performs an action on the basis of an external input. In addition, the transmission section 120 and the reception section 102 may transmit and receive the action plans 31 and 32 to and from a plurality of mobile bodies.

The mobile body recognition section 108 recognizes the second mobile body 20 and further recognizes an action of the second mobile body 20 on the basis of data measured by the sensor section 140. Specifically, the mobile body recognition section 108 may recognize the second mobile body 20 with use of a machine-learning-based recognition algorithm that takes an image, a distance, a shape, audio data, or the like as an input, or may recognize the second mobile body 20 with use of a rule-based recognition algorithm that detects an identification ID or the like. In addition, the mobile body recognition section 108 may recognize an action of the second mobile body 20 with use of a machine-learning-based recognition algorithm, or may recognize the action of the second mobile body 20 on the basis of measurement data by a sensor, such as a RADAR, that is able to measure velocity of the second mobile body 20. Specific processing of the mobile body recognition section 108 is described later.

The error detection section 106 detects error information between an action plan received from the second mobile body 20 and an action of the second mobile body 20 recognized by the mobile body recognition section 108. Specifically, the error detection section 106 detects whether or not there is an error between the action plan received from the second mobile body 20 and an actual action of the second mobile body 20 recognized by the mobile body recognition section 108, and a type and magnitude of the error. Specific processing of the error detection section 106 is described later.

The correction section 104 corrects the action plan of the second mobile body 20 on the basis of the error information by the error detection section 106. Specifically, the correction section 104 reflects the error information detected by the error detection section 106 to the action plan received from the second mobile body 20 to make an action plan with no or less error from the actual action of the second mobile body 20. Specific processing of the correction section 104 is described later.

This makes it possible for the controller 100 to correct the action plan received from the second mobile body 20 on the basis of the actual action of the observed second mobile body 20 and improve accuracy of the action plan of the second mobile body 20. This allows the controller 100 to refer to the corrected action plan of the second mobile body 20 and predict a future action of the second mobile body 20, which makes it possible to execute a cooperative action between the first mobile body 10 and the second mobile body 20 more smoothly. In addition, it is possible for the controller 100 to smoothly execute the cooperative action between the first mobile body 10 and the second mobile body 20 even in a case where there is an error in the action plan received from the second mobile body 20 or even in a case where accuracy of the action plan is low.

It is to be noted that the first mobile body 10 may cause the transmission section 120 to transmit the error information detected by the error detection section 106 to the second mobile body 20 and feed back that there is an error between the action plan and the actual action. This allows the second mobile body 20 to revise the body information of the second mobile body 20 on the basis of the transmitted error information to avoid an error between the action plan and the actual action. This allows the controller 100 to improve accuracy of both the actions of the first mobile body 10 and the second mobile body 20, which makes it possible to execute the cooperative action between the first mobile body 10 and the second mobile body 20 more smoothly.

As described above, the controller 100 is provided inside the first mobile body 10, but the present embodiment is not limited to the above example. The controller 100 may be provided outside the first mobile body 10, for example.

### <3. Specific Processing Example of Controller>

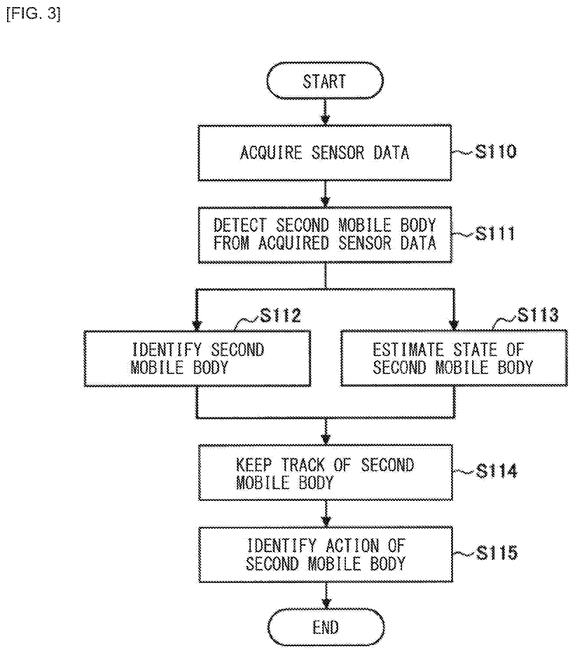

Next, specific processing examples of some components of the controller 100 according to the present embodiment are described with reference to FIGS. 3 to 8B.

### (Processing Example of Mobile Body Recognition Section 108)

First, a specific processing example of the mobile body recognition section 108 is described with reference to FIGS. 3 to 5. FIG. 3 is a flowchart illustrating an example of a flow of processing to be executed by the mobile body recognition section 108.

As illustrated in FIG. 3, the mobile body recognition section 108 first acquires measurement data from the sensor section 140 (S110). Next, the mobile body recognition section 108 detects the second mobile body 20 from the acquired measurement data (S111). Specifically, the mobile body recognition section 108 estimates a region where the second mobile body 20 exists from the measurement data observed by the sensor section 140.

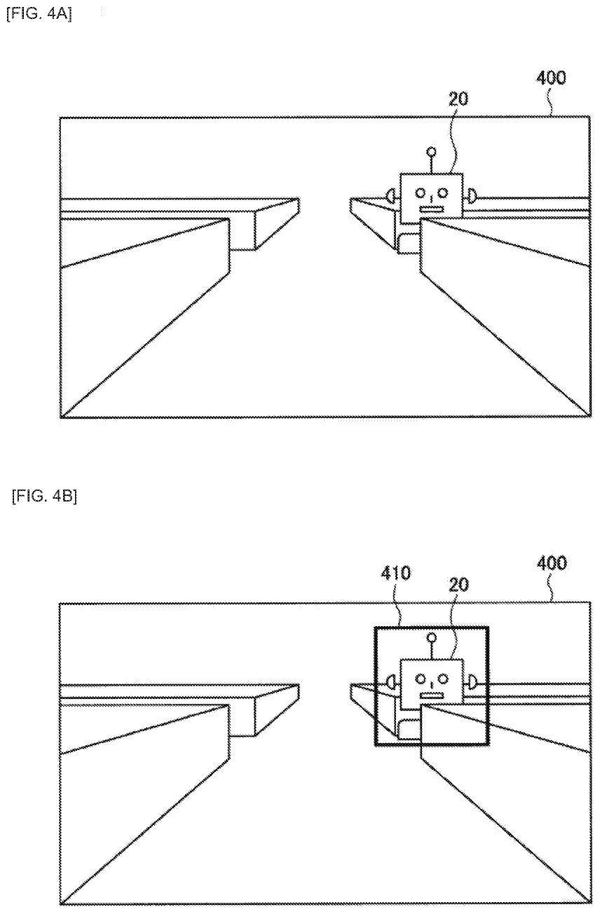

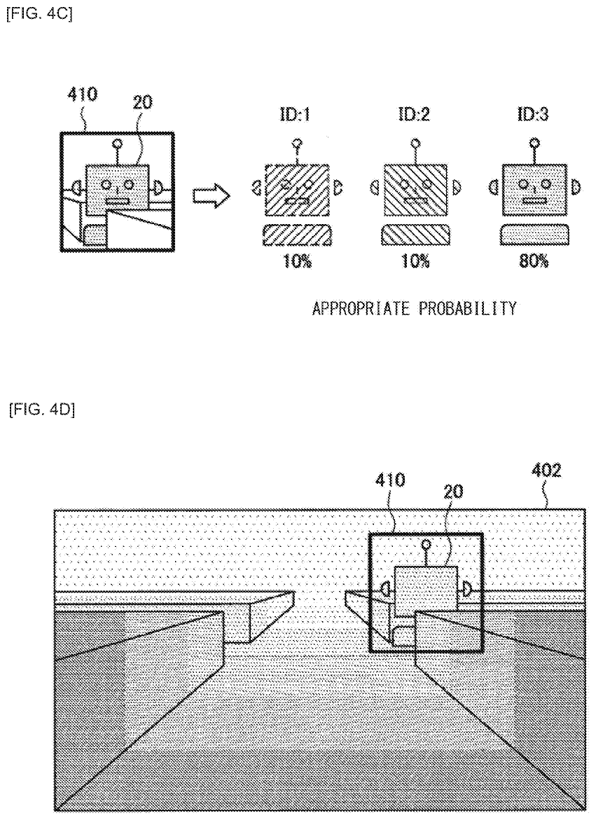

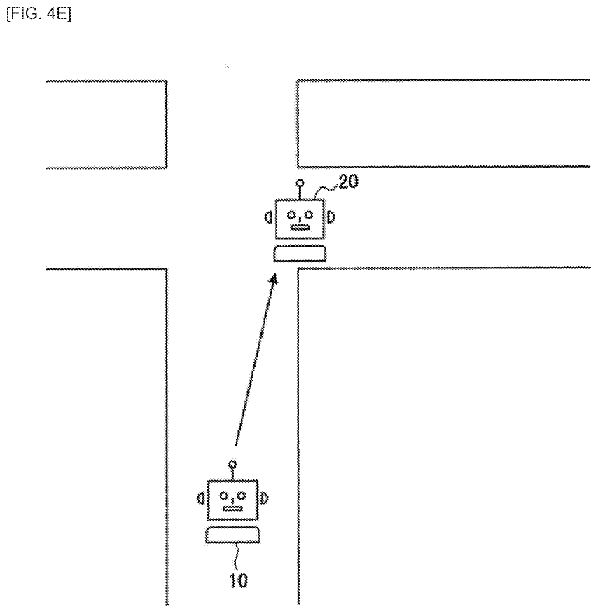

The mobile body recognition section 108 may detect the second mobile body 20 from the measurement data with use of the following method described with reference to FIGS. 4A to 4B. For example, in a case where an image 400 as illustrated in FIG. 4A is acquired as the measurement data, the mobile body recognition section 108 may estimate the region where the second mobile body 20 exists by image recognition. Next, the mobile body recognition section 108 may detect a rectangular or elliptical region where the second mobile body 20 is estimated to exist from the image 400 and output a detection region 410 as illustrated in FIG. 4B. In addition, in a case where a three-dimensional point group is acquired as the measurement data instead of a two-dimensional image, the mobile body recognition section 108 may output, as the detection region 410, a three-dimensional region, where the second mobile body 20 is estimated to exist, having a rectangular parallelepiped shape, a spherical shape, a mesh shape, or the like. It is to be noted that the mobile body recognition section 108 may output, as additional information, a certainty factor or the like that the second mobile body 20 is estimated to exist in the detection region 410.

Thereafter, the mobile body recognition section 108 identifies the second mobile body 20 (S112). Specifically, the mobile body recognition section 108 estimates an ID and the like that identify the second mobile body 20 existing in the detection region 410.

The mobile body recognition section 108 may identify the second mobile body 20 with use of the following method described with reference to FIG. 4C. For example, the mobile body recognition section 108 may estimate the ID and the like of the second mobile body 20 by causing a machine-learning-based recognition algorithm or a rule-based recognition algorithm to act on an image of the detection region 410 illustrated in FIG. 4B. In such a case, the mobile body recognition section 108 may present a plurality of mobile body candidates corresponding to the image of the detection region 410 and estimate an appropriate probability of each of the mobile body candidates, thereby outputting the ID of a mobile body having the highest probability as the ID of the second mobile body 20, as illustrated in FIG. 4C. For example, in FIG. 4C, the appropriate probabilities of the mobile bodies having IDs of “1” and “2” each are 10%, and the appropriate probability of the mobile body having an ID of “3” is 80%.

Accordingly, the mobile body recognition section 108 may output “3” as the ID of the second mobile body 20.

In addition, the mobile body recognition section 108 estimates the state of the second mobile body 20 (S113). It is to be noted that it is possible to execute estimation of the state of the second mobile body 20 (S113) simultaneously with identification of the second mobile body 20 (S112) described above. Specifically, the mobile body recognition section 108 estimates a position, an attitude, a joint angle, and the like of the second mobile body 20 on the basis of the measurement data from the sensor section 140. For example, the mobile body recognition section 108 may estimate a static state of the second mobile body 20 at the time of measurement by the sensor section 140. However, it is possible for the mobile body recognition section 108 to estimate a dynamic state of the second mobile body 20 depending on the type of the measurement data.

The mobile body recognition section 108 may estimate the state of the second mobile body 20 with use of the following method described with reference to FIGS. 4D and 4E. As illustrated in FIG. 4D, for example, the mobile body recognition section 108 may calculate an azimuth angle of and a distance from the detection region 410 on the basis of an image 402 that is acquired by a ToF camera or the like and represents a distance from an object in gray scale, and estimate the state of the second mobile body 20. In such a case, it is possible for the mobile body recognition section 108 to estimate a three-dimensional position of the second mobile body 20 by plotting the azimuth angle of and the distance from the second mobile body 20 on polar coordinates having first mobile body 10 as an origin point, as illustrated in FIG. 4E.

Subsequently, the mobile body recognition section 108 keeps track of the identified second mobile body 20 with a lapse of time (S114), thereby recognizing the action of the second mobile body 20 (S115). Specifically, the mobile body recognition section 108 estimates a motion state, such as a moving direction, velocity, or acceleration, of the second mobile body 20 by temporally accumulating the state of the second mobile body 20, and further estimate a longer-term action of the second mobile body 20 by temporally accumulating the motion state of the second mobile body 20.

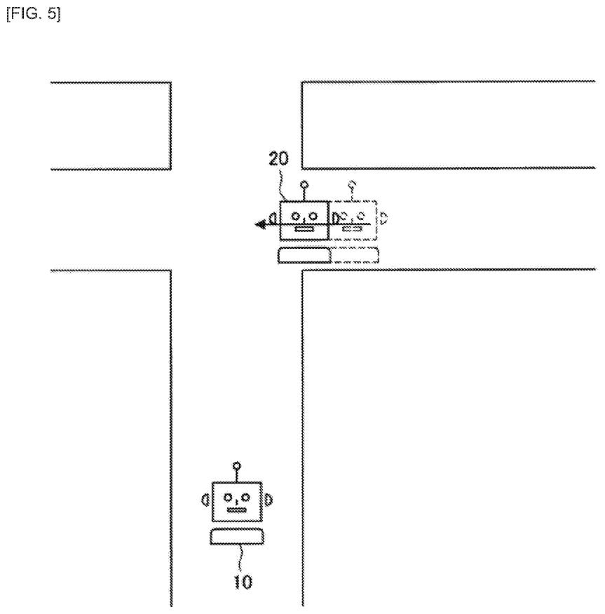

The mobile body recognition section 108 may recognize an action of the second mobile body 20 with use of the following method described with reference to FIG. 5. For example, as illustrated in FIG. 5, the mobile body recognition section 108 may estimate a traveling direction and velocity of the second mobile body 20 by temporally accumulating a position of the second mobile body 20. Here, in a case where a plurality of mobile bodies is detected within the same field of view, the mobile body recognition section 108 identifies each of the plurality of mobile bodies by the IDs and the like detected as described above, which makes it possible to associate each of the plurality of mobile bodies with a past state thereof.

### (Processing Example of Error Detection Section 106)

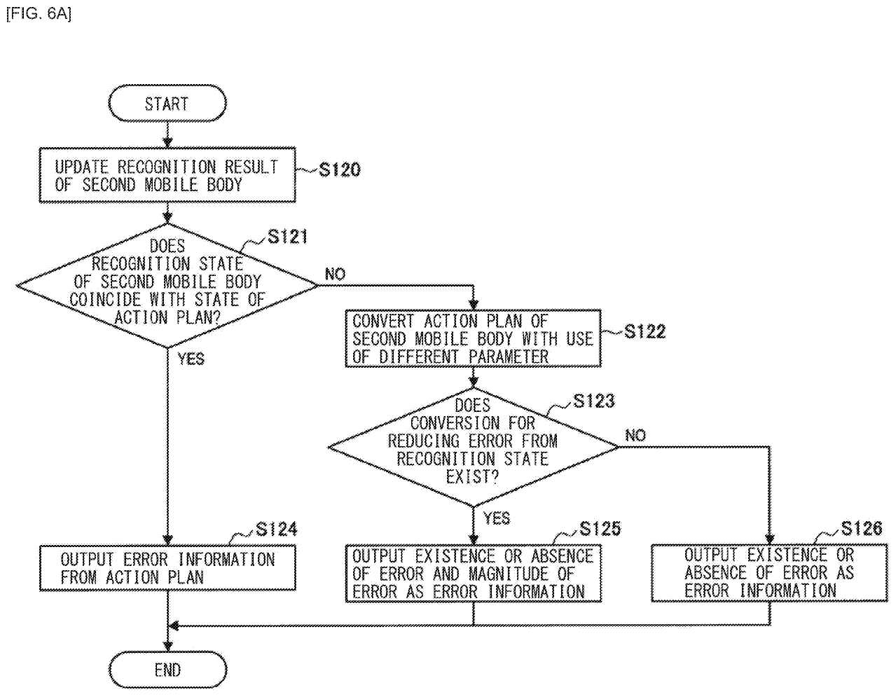

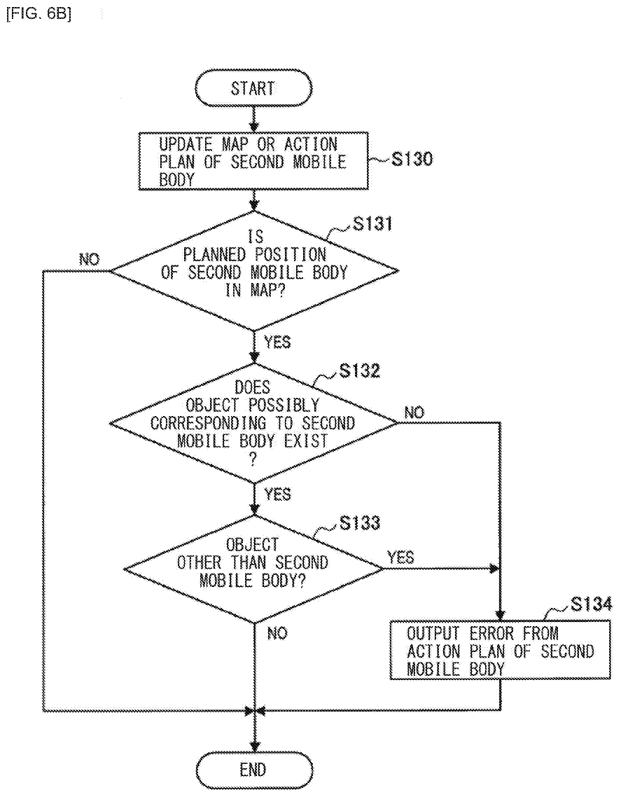

Next, a specific processing example of the error detection section 106 is described with reference to FIGS. 6A and 6B.

FIG. 6A is a flowchart illustrating an example of a flow of processing for detecting an error by comparing an action plan of the second mobile body 20 with an observation result of the second mobile body 20.

As illustrated in FIG. 6A, the error detection section 106 first updates a recognition result of the second mobile body 20 by the mobile body recognition section 108 (S120). Subsequently, the error detection section 106 determines whether or not an observed recognition state of the second mobile body 20 coincides with a state of the received action plan of the second mobile body 20 (S121). In a case where it is determined that the observed recognition state of the second mobile body 20 coincides with the state of the action plan of the second mobile body 20 (S121/Yes), the error detection section 106 outputs error information “with no error” (S124). It is to be noted that in a case where an error between the observed recognition state of the second mobile body 20 and the state of the action plan of the second mobile body 20 falls within a planned range, the error detection section 106 may determine that the observed recognition state of the second mobile body 20 coincides with the state of the action plan of the second mobile body 20.

In contrast, in a case where it is determined that the observed recognition state of the second mobile body 20 does not coincide with the state of the action plan of the second mobile body 20 (S121/No), the error detection section 106 converts the action plan of the second mobile body 20 with use of a different parameter to make the converted action plan of the second mobile body 20 (S122). It is to be noted that examples of a parameter to be converted may include the position, the attitude, the velocity, the angular velocity, the time, the position distribution, or the like of the second mobile body 20.

Here, the error detection section 106 determines whether or not the converted action plan of the second mobile body 20 includes an action plan for reducing the error from the recognition state of the observed second mobile body 20 as compared with the action plan before being converted of the second mobile body 20 (S123). In a case where the action plan for reducing the error from the recognition state of the observed second mobile body 20 exists (S123/Yes), the error detection section 106 outputs error information “with error.” In addition, the error detection section 106 outputs a type of conversion for reducing the error and a modification amount as magnitude of the error (S125). In contrast, in a case where the action plan for reducing the error from the recognition state of the observed second mobile body 20 does not exist or is not found (S123/No), the error detection section 106 outputs error information “with error.” In such a case, the error detection section 106 also outputs information that the type of conversion for reducing the error and the modification amount are unknown (S126).

FIG. 6B is a flowchart illustrating an example of a flow of processing for detecting an error that the second mobile body 20 is not observed.

As illustrated in FIG. 6B, the error detection section 106 first updates a recognition result of the second mobile body 20 by the mobile body recognition section 108 or the outside world map created by the map creation section 114 (S130). Next, the error detection section 106 determines whether or not the time and the position of the second mobile body 20 in the action plan are included in a map region of the outside world (S131).

In a case where the time and the position of the second mobile body 20 in the action plan are included in the map region of the outside world (S131/Yes), the error detection section 106 determines whether or not an object corresponding to the second mobile body 20 exists in the map region of the outside world (S132). In a case where the object corresponding to the second mobile body 20 does not exist in the map region of the outside world (S132/No), the error detection section 106 outputs error information “with error” indicating that the second mobile body 20 does not exist. In contrast, in a case where the object corresponding to the second mobile body 20 exists in the map region of the outside world (S132/Yes), the error detection section 106 determines whether or not the existing object is an object other than the second mobile body 20 (S133). In a case where the existing object is an object other than the second mobile body 20 (S133/Yes), the error detection section 106 outputs error information “with error” indicating that the second mobile body 20 does not exist.

It is to be noted that in a case where the time and the position of the second mobile body 20 in the action plan are not included in the map region of the outside world (S131/No), or in a case where the second mobile body 20 exits in the map region of the outside world (S133/No), the error detection section 106 ends processing on the assumption that no error has been detected.

### (Processing Example of Correction Section 104)

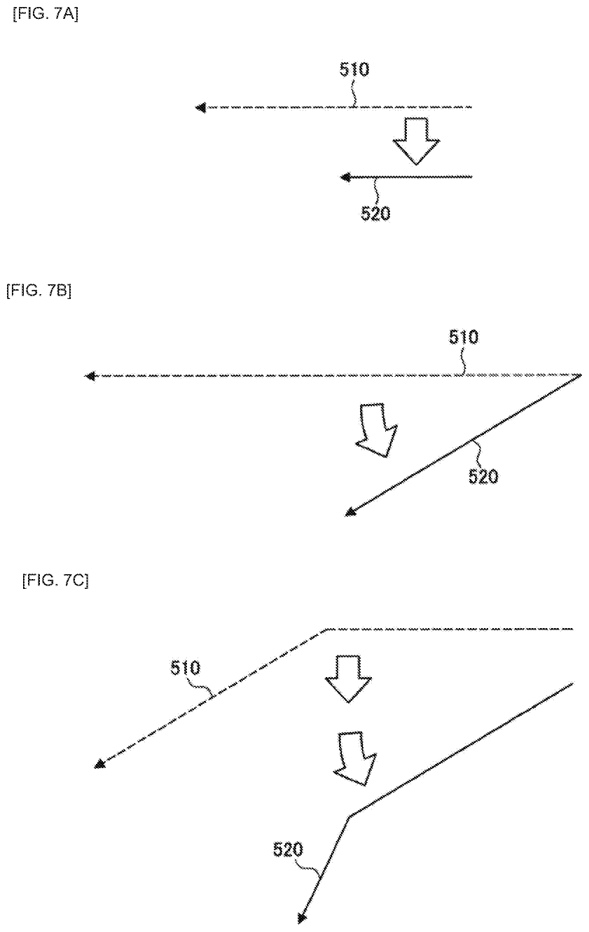

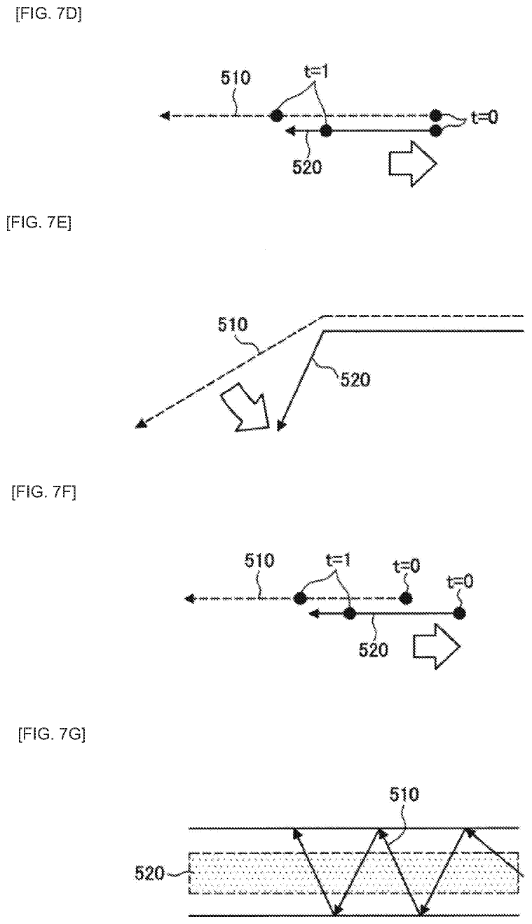

Next, a specific processing example of the correction section 104 is described with reference to FIGS. 7A to 7G. FIGS. 7A to 7G are explanatory diagrams illustrating variations of an error and correction.

The correction section 104 corrects the action plan of the second mobile body 20 on the basis of the error detected by the error detection section 106.

For example, in a case where there is no error between the action plan and the observation result of the second mobile body 20, the correction section 104 outputs the received action plan of the second mobile body 20 as it is.

In a case where there is an error between the action plan and the observation result of the second mobile body 20 and there is conversion for reducing the error, the correction section 104 outputs an action plan obtained by subjecting the received action plan of the second mobile body 20 to the conversion for reducing the error.

For example, as illustrated in FIG. 7A, in a case where a position of an observation result 520 of the second mobile body 20 is different from that of an action plan 510 of the second mobile body 20, the correction section 104 may subject the action plan to correction for changing the position of the second mobile body 20. As illustrated in FIG. 7B, in a case where an attitude of the observation result 520 of the second mobile body 20 is different from that of the action plan 510 of the second mobile body 20, the correction section 104 may subject the action plan to correction for changing the attitude of the second mobile body 20. As illustrated in FIG. 7C, in a case where both the position and the attitude of the observation result 520 of the second mobile body 20 are different from those of the action plan 510 of the second mobile body 20, the correction section 104 may subject the action plan to correction for changing the position and the attitude of the second mobile body 20. As illustrated in FIG. 7D, in a case where velocity of the observation result 520 of the second mobile body 20 is different from that of the action plan 510 of the second mobile body 20, the correction section 104 may subject the action plan to correction for changing the velocity of the second mobile body 20. As illustrated in FIG. 7E, in a case where angular velocity of the observation result 520 of the second mobile body 20 is different from that of the action plan 510 of the second mobile body 20, the correction section 104 may subject the action plan to correction for changing the angular velocity of the second mobile body 20. As illustrated in FIG. 7F, in a case where time of an action of the observation result 520 of the second mobile body 20 is different from that of the action plan 510 of the second mobile body 20, the correction section 104 may subject the action plan to correction for changing the time of the action of the second mobile body 20. As illustrated in FIG. 7G, in a case where positional variation of the observation result 520 of the second mobile body 20 is large as compared with that of the action plan 510 of the second mobile body 20, the correction section 104 may subject the action plan to correction for increasing distribution of the position of the second mobile body 20.

In a case where there is an error between the action plan and the observation result of the second mobile body 20 and conversion for reducing the error is unknown, the correction section 104 makes an action plan predicted from the observation result of the second mobile body 20 on the basis of the received action plan of the second mobile body 20. At this time, the correction section 104 may represent uncertainty of the action plan by increasing distribution of the state (that is, the position and the velocity) of the action plan of the second mobile body 20.

In a case of an error that the second mobile body 20 has not been observed, the correction section 104 may determine that the received action plan of the second mobile body 20 has been cancelled, and call off the received action plan of the second mobile body 20. Alternatively, the correction section 104 may output the received action plan of the second mobile body 20 as it is to avoid a risk caused by correcting the received action plan of the second mobile body 20.

(Processing Examples of Plan Map Creation Section 112 and Action Planning section 118)

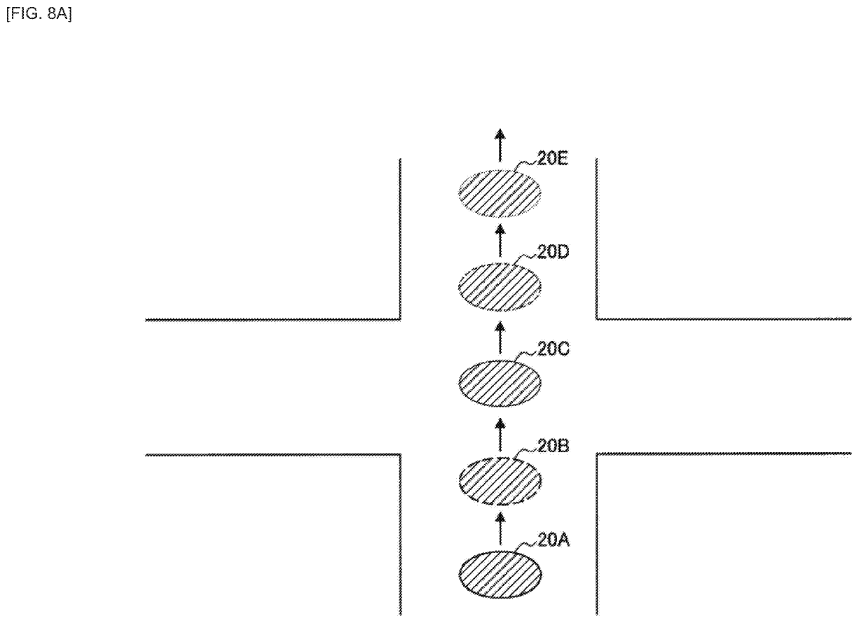

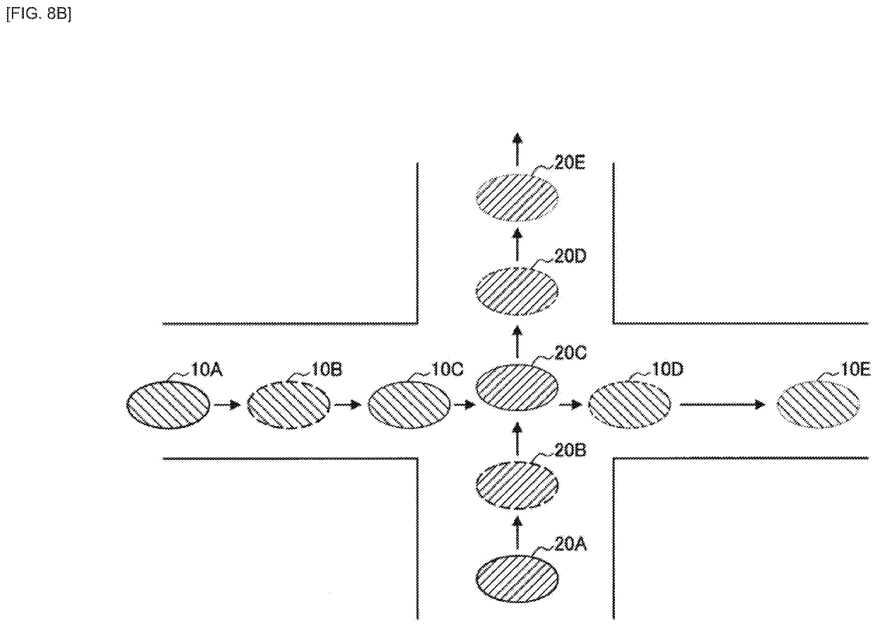

Next, specific processing examples of the plan map creation section 112 and the action planning section 118 are described with reference to FIGS. 8A and 8B. The FIG. 8A is an explanatory diagram illustrating a specific example of an action plan map that reflects the action plan of the second mobile body 20, and FIG. 8B is an explanatory diagram illustrating an example of an action plan of the first mobile body 10 planned on the basis of the action plan map illustrated in FIG. 8A.

For example, the plan map creation section 112 may create an action plan map for movement of the first mobile body 10 on the basis of the outside world map created by the map creation section 114 and the action plan of the second mobile body 20 corrected by the correction section 104.

In such a case, the plan map creation section 112 creates a map specifying a region passable by the first mobile body 10 by adding the action plan of the second mobile body 20 to an outside world obstacle map indicating existence or absence of an obstacle or existence probability of an obstacle in each region of the outside world. This allows the plan map creation section 112 to create an action plan map for movement of the first mobile body 10.

For example, setting a region where an obstacle or the second mobile body 20 exists as an obstacle region that is not passable and setting a region other than the obstacle region as a passable region makes it possible for the plan map creation section 112 to create the action plan map for movement of the first mobile body 10. It is to be noted that in a case where it is desired to move the first mobile body 10 away from the obstacle or the second mobile body 20, the plan map creation section 112 expands the obstacle region and limits the passable region, which makes it possible to limit a moving route of the first mobile body 10.

FIG. 8A illustrates an example of an action plan map to which positions of the second mobile body 20 on the basis of the action plan are added as ellipses 20A to 20E to the outside world obstacle map. The ellipses 20A to 20E each represent the position of the second mobile body 20 at each time, and indicate that the position of the second mobile body 20 moves in order of the ellipses 20A to 20E with a lapse of time.

In a case where the action plan of the first mobile body 10 is created with use of the action plan map illustrated in FIG. 8A, the action planning section 118 sets the moving route of the first mobile body 10 not to come into contact with the obstacle and the second mobile body 20.

In FIG. 8B, positions of the first mobile body 10 are represented by ellipses 10A to 10E. The ellipses 10A to 10E each represent the position of the first mobile body 10 at each time, and indicate that the position of the first mobile body 10 moves in order of the ellipses 10A to 10E with a lapse of time. The ellipse 10A and the ellipse 20A represent the positions of the first mobile body 10 and the second mobile body at the same time, and similarly, the ellipse 10B and the ellipse 20B, the ellipse 10C and the ellipse 20C, the ellipse 10D and the ellipse 20D, and the ellipse 10E and the ellipse 20E each represent the positions of the first mobile body 10 and the second mobile body at the same time.

Referring to FIG. 8B, the first mobile body 10 is slowed down in front of a crossroads (the ellipses 10A to 10C) to avoid coming into contact or collision with the second mobile body 20, and enters the crossroads (the ellipses 10D to 10E) after the second mobile body 20 has passed through the crossroads (the ellipse 20C). This allows the action planning section 118 to set the moving route of the first mobile body 10 that avoids coming into contact or collision with an obstacle or the second mobile body 20.

### <4. Operation Example of Controller>

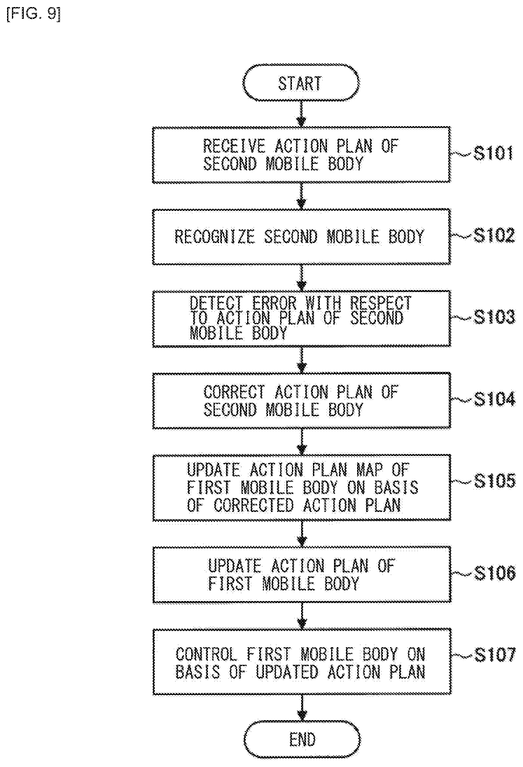

Next, a general flow of the operation of the controller 100 according to the present embodiment is described with reference to FIG. 9. FIG. 9 is a flowchart illustrating an operation example of the controller 100 according to the present embodiment.

As illustrated in FIG. 9, the controller 100 first receives an action plan from the second mobile body 20 in the reception section 102 (S101). Thereafter, the controller 100 recognizes the second mobile body 20 in the mobile body recognition section 108 (S102). Subsequently, the controller 100 detects an error of an observation result of the second mobile body 20 with respect to the action plan of the second mobile body 20 in the error detection section 106 (S103). Furthermore, the controller 100 corrects the action plan of the second mobile body 20 on the basis of the detected error in the correction section 104 (S104), and updates the action plan map of the first mobile body 10 on the basis of the corrected action plan in the plan map creation section 112 (S105). Thereafter, the controller 100 updates the action plan of the first mobile body 10 on the basis of the updated action plan map in the action planning section 118 (S106). This allows the controller 100 to control the action of the first mobile body 10 on the basis of the updated action plan in the drive control section 122 (S107).

Even in a case where there is an error in the action plan of the second mobile body 20, the operation described above makes it possible for the controller 100 according to the present embodiment to correct the error on the basis of an actual action of the second mobile body 20 and update the action plan of the first mobile body 10. This allows the controller 100 according to the present embodiment to smoothly execute the cooperative action between the first mobile body 10 and the second mobile body 20.

### <5. Hardware Configuration Example>

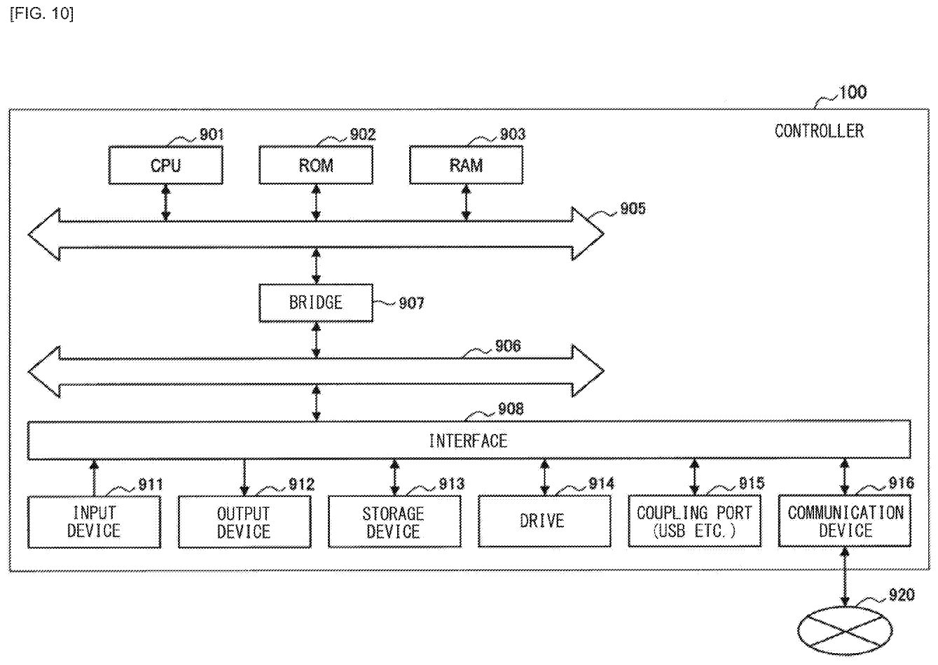

Next, a hardware configuration of the controller 100 according to the present embodiment is described with reference to FIG. 10. FIG. 10 is a block diagram illustrating an example of the hardware configuration of the controller 100 according to the present embodiment.

As illustrated in FIG. 10, the controller 100 includes a CPU (Central Processing Unit) 901, a ROM (Read Only Memory) 902, a RAM (Random Access Memory) 903, a bridge 907, internal buses 905 and 906, an interface 908, an input device 911, an output device 912, a storage device 913, a drive 914, a coupling port 915, and a communication device 916.

The CPU 901 functions as an arithmetic processing device, and controls an overall operation of the controller 100 in accordance with various programs. The ROM 902 stores a program to be used by the CPU 901 and an arithmetic parameter. The RAM 903 temporarily stores a program to be used in execution of the CPU 901, a parameter to be appropriately changed in the execution, and the like. For example, the CPU 901 may execute functions of the correction section 104, the error detection section 106, the mobile body recognition section 108, the information management section 110, the plan map creation section 112, the map creation section 114, the recognition section 116, the action planning section 118, and the drive control section 122.

The CPU 901, the ROM 902, and the RAM 903 are coupled to each other by the bridge 907, the internal buses 905 and 906, and the like. In addition, the CPU 901, the ROM 902, and the RAM 903 are coupled to the input device 911, the output device 912, the storage device 913, the drive 914, the coupling port 915, and the communication device 916 via the interface 908.

The input device 911 includes input devices to which information is inputted, such as a touch panel, a keyboard, a mouse, a button, a microphone, a switch, and a lever. In addition, the input device 911 includes an input control circuit that generates an input signal on the basis of inputted information and outputs the input signal to the CPU 901, and the like.

The output device 912 includes a display device such as a CRT display device, a liquid crystal display device, or an organic EL (Organic ElectroLuminescence) display device. Further, the output device 912 may include an audio output device such as a speaker or headphones.

The storage device 913 is a storage device for data storage of the controller 100. The storage device 913 may include a storage medium, a storage device that stores data in the storage medium, a reading device that reads data from the storage medium, and a deletion device that deletes data stored in the storage medium.

The drive 914 is a reader/writer for a storage medium, and is incorporated in or externally attached to the controller 100. The drive 914 reads information stored in a removable storage medium such as a magnetic disk, an optical disc, a magneto-optical disk, or a semiconductor memory mounted thereon, and outputs the information to the RAM 903. The drive 914 is also able to write information into the removable storage medium.

The coupling port 915 is a coupling interface including a coupling port for coupling of an external coupling device such as a USB (Universal Serial Bus) port, an Ethernet (registered trademark) port, an IEEE 802.11 standard port, or an optical audio terminal.

The communication device 916 is a communication interface including, for example, a communication device and the like for coupling to a network 920. In addition, the communication device 916 may include a wired or wireless LAN compatible communication device, or a cable communication device that performs cable communication through wires. The communication device 916 may execute functions of the reception section 102 and the transmission section 120.

It is to be noted that it is possible to create a computer program for achieving a function equivalent to that of each component of the controller according to the present embodiment described above for hardware such as a CPU, a ROM, and a RAM incorporated in the controller 100. In addition, it is also possible to provide a storage medium having such a computer program stored therein.

### <6. Conclusion>

According to the controller 100 according to the present embodiment described above, even in a case where there is an error in the action plan of the second mobile body 20, it is possible to correct the action plan of the second mobile body 20 on the basis of an observation result of the second mobile body 20. This allows the controller 100 to predict a future action after observation of the second mobile body 20.

In addition, according to the controller 100 according to the present embodiment, even in a case where the action plan of the second mobile body 20 is inaccurate, it is possible to correct the action plan of the second mobile body 20, and update the action plan of the first mobile body 10 on the basis of the thus-corrected action plan. This allows the controller 100 to smoothly execute the cooperative action between the first mobile body 10 and the second mobile body 20.

In addition, according to the controller 100 according to the present embodiment, correcting the action plan of the second mobile body 20 on the basis of the action of the observed second mobile body 20 makes it possible to improve accuracy of the action plan of the second mobile body. This allows the controller 100 to execute the cooperative action between the first mobile body 10 and the second mobile body 20 with higher accuracy.

In addition, according to the controller 100 according to the present embodiment, it is possible to predict the action plan of the second mobile body 20 on the basis of an action of an observation result of the second mobile body 20. This allows the controller 100 to smoothly execute the cooperative action between the first mobile body 10 and the second mobile body 20 even in a case where frequency of sharing the action plan between the first mobile body 10 and the second mobile body 20 is reduced.

Further, according to the controller 100 according to the present embodiment, even in a case where, in a system including a plurality of mobile bodies, some mobile bodies stop, it is possible to perceive, by another mobile body, existence of a mobile body that does not perform an action according to an action plan. In such a case, it is possible for the controller 100 to remake an action plan of the other mobile body in consideration of existence of the stopped mobile body, which makes it possible to improve robustness of the system including the plurality of mobile bodies.

A preferred embodiment(s) of the present disclosure has/have been described above in detail with reference to the accompanying drawings, but the technical scope of the present disclosure is not limited to such an embodiment(s). It is apparent that a person having ordinary skill in the art of the present disclosure may arrive at various alterations and modifications within the scope of the technical idea described in the appended claims, and it is understood that such alterations and modifications naturally fall within the technical scope of the present disclosure.

For example, in the embodiment described above, the controller 100 creates an action plan map for making an action plan of a mobile body, but the present technology is not limited to such an example. For example, the controller 100 may create an action plan map of not only the mobile body but also a robot (an autonomous action robot) that autonomously acts on the basis of an action plan. Specifically, the controller 100 may create an action plan map of an industrial robot device such as a vertically articulated robot that does not move, or may create an action plan map of a projection robot device that performs projection mapping.

In addition, the effects described herein are merely illustrative and exemplary, but not limitative. That is, the technology according to the present disclosure may exert other effects that are apparent to those skilled in the art from the description herein, in addition to the above-described effects or in place of the above-described effects.

It is to be noted that the following configurations also fall within the technical scope of the present disclosure.

(1)

A controller including:
a plan map creation section that creates an action plan map for making an action plan of a first mobile body from an outside world map with use of an action plan of a second mobile body; and
an error detection section that detects an error between the action plan of the second mobile body and an observation result of an action of the second mobile body,
the plan map creation section updating the action plan map with use of the detected error.
   (2)

The controller according to (1), further including an action planning section that makes the action plan of the first mobile body on the basis of the action plan map.

(3)

The controller according to (2), in which the action planning section updates the action plan of the first mobile body in a case where the action plan map is updated.

(4)

The controller according to any one of (1) to (3), further including a correction section that performs correction for reducing the error detected by the error detection section, in which
the plan map creation section updates the action plan map with use of the action plan subjected to the correction of the second mobile body.
   (5)

The controller according to any one of (1) to (3), in which the plan map creation section updates the action plan map with use of an action plan of the second mobile body predicted on the basis of the observation result of the action of the second mobile body.

(6)

The controller according to any one of (1) to (5), in which the plan map creation section further uses body information of the first mobile body to create the action plan map.

(7)

The controller according to any one of (1) to (6), further including a reception section that receives the action plan of the second mobile body.

(8)

The controller according to (7), further including an information management section that manages body information of the first mobile body, in which
the reception section further receives an error between the action plan of the first mobile body and an observation result of an action of the first mobile body, and
the information management section updates the body information of the first mobile body on the basis of the received error.
   (9)

The controller according to any one of (1) to (8), further including a transmission section that transmits the error detected by the error detection section to the second mobile body.

(10)

The controller according to any one of (1) to (9), in which the outside world map is created on the basis of an observation result by a sensor section included in the first mobile body.

(11)

The controller according to (7) or (8), in which
the reception section further receives body information of the second mobile body, and
the second mobile body is recognized from an observation result by a sensor section included in the first mobile body on the basis of the body information of the second mobile body.
   (12)

The controller according to (11), in which the action of the second mobile body is recognized by temporally accumulating the observation result by the sensor section.

(13)

The controller according to any one of (1) to (12), in which the plan map creation section creates the action plan map of the first mobile body by adding information affecting an action of the first mobile body to the outside world map.

(14)

The controller according to any one of (1) to (13), in which the plan map creation section creates a plurality of the action plan maps in accordance with on different uses or conditions.

(15)

The controller according to any one of (1) to (14), in which the action plan map includes a temporal axis in a coordinate system.

(16)

A control method including:
creating an action plan map for creating an action plan of a first mobile body from an outside world map with use of an action plan of a second mobile body;
detecting an error between the action plan of the second mobile body and an observation result of an action of the second mobile body; and
updating the action plan map with use of the detected error.
   (16)

A program for causing a computer to function as:
a plan map creation section that creates an action plan map for making an action plan of a first mobile body from an outside world map with use of an action plan of a second mobile body; and
an error detection section that detects an error between the action plan of the second mobile body and an observation result of an action of the second mobile body,
the plan map creation section being caused to function to update the action plan map with use of the detected error.

### REFERENCE SIGNS LIST

10: first mobile body

20: second mobile body

31: action plan

32: action plan

100: controller

102: reception section

104: correction section

106: error detection section

108: mobile body recognition section

110: information management section

112: plan map creation section

114: map creation section

116: recognition section

118: action planning section

120: transmission section

122: drive control section

140: sensor section

160: drive section

1. A controller comprising:
a plan map creation section that creates an action plan map for making an action plan of a first mobile body from an outside world map with use of an action plan of a second mobile body; and
an error detection section that detects an error between the action plan of the second mobile body and an observation result of an action of the second mobile body,
the plan map creation section updating the action plan map with use of the detected error.

2. The controller according to claim 1, further comprising an action planning section that makes the action plan of the first mobile body on a basis of the action plan map.

3. The controller according to claim 2, wherein the action planning section updates the action plan of the first mobile body in a case where the action plan map is updated.

4. The controller according to claim 1, further comprising a correction section that performs correction for reducing the error detected by the error detection section, wherein
the plan map creation section updates the action plan map with use of the action plan subjected to the correction of the second mobile body.

5. The controller according to claim 1, wherein the plan map creation section updates the action plan map with use of an action plan of the second mobile body predicted on a basis of the observation result of the action of the second mobile body.

6. The controller according to claim 1, wherein the plan map creation section further uses body information of the first mobile body to create the action plan map.

7. The controller according to claim 1, further comprising a reception section that receives the action plan of the second mobile body.

8. The controller according to claim 7, further comprising an information management section that manages body information of the first mobile body, wherein
the reception section further receives an error between the action plan of the first mobile body and an observation result of an action of the first mobile body, and
the information management section updates the body information of the first mobile body on a basis of the received error.

9. The controller according to claim 1, further comprising a transmission section that transmits the error detected by the error detection section to the second mobile body.

10. The controller according to claim 1, wherein the outside world map is created on a basis of an observation result by a sensor section included in the first mobile body.

11. The controller according to claim 7, wherein
the reception section further receives body information of the second mobile body, and
the second mobile body is recognized from an observation result by a sensor section included in the first mobile body on a basis of the body information of the second mobile body.

12. The controller according to claim 11, wherein the action of the second mobile body is recognized by temporally accumulating the observation result by the sensor section.

13. The controller according to claim 1, wherein the plan map creation section creates the action plan map of the first mobile body by adding information affecting an action of the first mobile body to the outside world map.

14. The controller according to claim 1, wherein the plan map creation section creates a plurality of the action plan maps in accordance with on different uses or conditions.

15. The controller according to claim 1, wherein the action plan map includes a temporal axis in a coordinate system.

16. A control method comprising:
creating an action plan map for creating an action plan of a first mobile body from an outside world map with use of an action plan of a second mobile body;
detecting an error between the action plan of the second mobile body and an observation result of an action of the second mobile body; and
updating the action plan map with use of the detected error.

17. A program for causing a computer to function as:
a plan map creation section that creates an action plan map for making an action plan of a first mobile body from an outside world map with use of an action plan of a second mobile body; and
an error detection section that detects an error between the action plan of the second mobile body and an observation result of an action of the second mobile body,
the plan map creation section being caused to function to update the action plan map with use of the detected error.
